(19) United States
(12) Patent Application Publication
(10) Pub. No.: US 2003/0033227 A1
(43) Pub. Date: Feb. 13, 2003

(54) Multi-level software for generating wills and trusts online

(76) Inventor: Kenneth Gabriel Heiser, Brentwood, TN (US)

Correspondence Address: Albert T. Keyack, 1005 Glendevon Drive, Ambler, PA, 19002, US

(21) Appl. No.: 09/928,009

(22) Filed: Aug. 10, 2001

(51) Int. Cl. G06F 17/60; G09G 5/00

(52) U.S. Cl. 705/35; 345/780; 345/749

(57) ABSTRACT

The present invention provides methods for automatically generating a will or trust document by providing a user with a plurality of input screens, arranged in a sequential and logical order, that include one or more screens requiring: personal and family information, financial information, asset information, estate distribution selections, trust parameter selection, and guardian and trustee selections and then processing data input by an end-user to automatically create a will or trust document. Preferably, the method also includes selectively precluding a user from viewing a second screen subsequent a first screen until data is entered into said first screen. In certain preferred embodiments, the methods of the present invention will be carried out only after performing a prefatory step of selecting between a plurality of levels of complexity, wherein each level of complexity requires less input data from said input screens, and most preferably there are three levels of complexity.

The present invention relates to computer software, and more particularly to software used to create an interactive website and to methods of conducting business using the Internet.

### BACKGROUND OF THE INVENTION

Systems that allow an end user to input user-specific information into a form to generate a will or trust document are known. Generally, such systems are limited in that they permit only basic selections to be made by the end user with regard to the complexity of such documents, for example choosing between a simple or complex will. Additionally, some systems provide the end user with form document choices that are placed in categories determined by statutory requirements, such as the size of the estate or whether or not minor children are involved.

As with many software applications, software programs that assist in the generation of wills are now widespread on the Internet. For example, the website http://www.newyorklawyers.com provides a questionnaire that asks a user to insert information into a form, and makes some recommendations, driven by statutory requirements, such as a child reaching majority age before receiving an outright gift, or that an executor hold a bequest in trust for a minor. The website http://www.legalzoom.com provides simple legal forms to be filled out by end users without the assistance of an attorney. Similarly, http://www.webpowers.com/internetwills/questionnaire.htm offers a user the choice of form wills, and the form wills are described by basic criteria such as simple reciprocal wills to a spouse, or a simple will bequeathing an estate to one's children or to a selected a charity. In all the variants, the end user (testator) decides the beneficiaries and simply fills out the form. This site like many, is essentially an “order form” in which the data are taken in and inserted into a pre-determined will document.

In this manner, the Internet and the software behind it are largely used to facilitate a transaction for legal services, rather than utilize logic and interactivity. For example, the website http://www.lawpartners.com.au/wills/index.php is an Australian site that is connected to a specific law firm, and permits a user to enter basic information to create a simple will. The website http://www.law-ohio.com/willform.html is an attorney website that offers forms for wills and trusts of varying complexity, ranging from simple wills to various trusts and Durable Power of Attorney documents. The site is essentially an order form and provides no computed selection based on consumer needs or profile data. Another website, http://www.onlinewills.com, allows a user to self-select a will form that in the user's opinion fits their needs. When using the latter site, the end user answers a series of questions and the answers to the questions help create a form will. There are six types of wills that are categorized based again on statutory requirements such as marital status, size of estate, and the existence of children. The user “selects a will that fits you” from a pre-determined set of forms, while the website http://www.completewills.co.uk/about.asp is a British site run by the equivalent of an attorney, and elicits only basic information from the testator. The website http://www.uklaw.net/uklawdotnet/services/secure/std/willform.htm is another British site that requires the user to fill in blanks that provide basic information and will result in a simple will, and http://www.netstrike.com/secure/nyl/willform.htm is a lawyer's site that provides a questionnaire that the end user proceeds through linearly, filling in each box, or leaving a null entry.

Therefore, although it is generally possible to generate simple wills online, and certain types of more comprehensive will forms are available online, there exists a long-felt but as of yet unmet need to provide an automated system whereby the user is first interrogated to determine what type of will or trust is appropriate, using data input by the user and not simply defined in broad statutory categories.

A completely different category of software is also known that permits users to manipulate financial and other personal data to effect financial transactions or manage finances within a specified set of parameters. For example, U.S. Pat. No. 5,537,315—Mitcham discloses a method for issuing insurance from a kiosk and creating and authenticating a signature. U.S. Pat. No. 5,913,198—Banks discloses a system for designing and administering self-funded survivor benefit plans. The software has plan administration and investment modules; the latter manages contributions to an investment vehicle. The software also extracts participant (employee) information from a database, models survivor benefits, and provides administration to manage operation of the plan. U.S. Pat. No. 6,012,043—Albright, et al. discloses a financial planning tool that produces estimated values of needed savings levels and further income based on certain economic assumptions and data regarding a user's financial status. U.S. Pat. No. 6,092,047—Hyman, et al. discloses devising the financial aspects of a plan of benefits for a given employee population in accordance with goals set by the employer, not he individuals. However, none of the above-described software programs is directed to the financial management calculations necessary in estate planning, and in particular, none of them functions in an integrated manner with further software capable of generating a will or trust document.

### SUMMARY OF THE INVENTION

The present invention provides methods for automatically generating a will document by providing a user with a plurality of input screens, arranged in a sequential and logical order, that include one or more screens requiring: personal and family information, financial information, asset information, estate distribution selections, trust parameter selection, and guardian and trustee selections and then processing data input by an end-user to automatically create a will or trust document. Preferably, the method also includes selectively precluding a user from viewing a second screen subsequent to a first screen until data is entered into said first screen. In certain preferred embodiments, the methods of the present invention will be carried out only after performing a prefatory step of selecting between a plurality of levels of complexity, wherein each level of complexity requires less input data from said input screens, and most preferably there are three levels of complexity.

Thus, in one aspect, the present invention provides a software program for effecting an interactive process that has at least three levels of interaction, one of which is selected by an end user. The three levels preferably include a first level in which a user inputs a first data set and a null entry is not permitted, a second level of less complexity where the software program makes assumptions based on limited data input by an end user, and a third level of less complexity than said second level in which the software program selects between several pre-determined outputs based upon basic data input by the end user. In a preferred embodiment, the interactive process is the process of generating a will or trust.

The present invention also provides methods of generating a will or trust documents using a computing device in which a plurality of data entry questions to collect personal and financial data are provided and data are processed to calculate net worth and other parameters relevant to a will or trust, and a printable document that includes both data entered directly by an end user and data derived from data entered by an end user is created. Once again, it is preferred that there be a prefatory step of selecting between one more levels of complexity for the document. And it is most preferable that there are three levels of complexity and that processing the data to create a printed document is precluded if a null value is entered for one or more of said data entry questions.

### BRIEF DESCRIPTION OF THE DRAWINGS

FIG. 1 is a block diagram schematic showing the relative relationship of functional portions of the website that represents a preferred embodiment of the present invention.

### DETAILED DESCRIPTION OF THE PREFERRED EMBODIMENTS

The function and use of the methods of the present invention is described herein with reference to software, and in particular software that is placed on a server connected to a network such as the Internet. Those of skill in the art will understand that the systems described herein may be run on any computing device or platform available now or in the future, including, but not limited to: PCs, network work stations, PDAs, or any other device that permits data input, processing and display or printing. Similarly, the device or devices may be stand-alone or networked, and such network may be a private or proprietary network, a LAN, or a public network such as the Internet or some subset of a network.

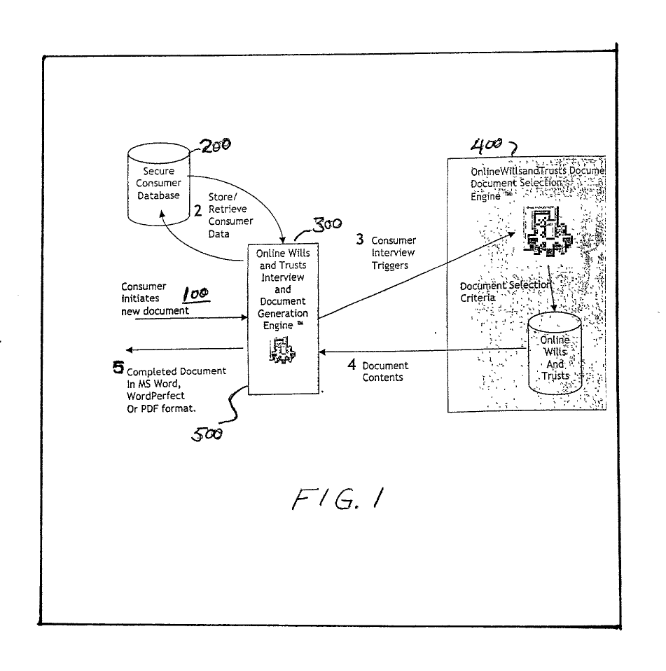

Referring now to FIG. 1 there is shown a schematic functional diagram of a preferred embodiment of the present invention. Generally, the end user or “consumer” initiates the creation of a new document using a first input screen, as shown at step 100. This action will preferably incorporate or initiate retrieval or fetching algorithm that will store new data input and retrieve data relevant to that particular end user if the session is one that is updating or reformulating a previously processed document, or if the session is one that follows an interrupted session in which a document was not completed. The initiation 100 and retrieval of data 200 are part of the process of initializing a document and form one aspect of the present invention wherein a consumer chooses between levels of sophistication. These steps together trigger an “interview” 400 that forms another aspect of the present invention and which is set forth in additional detail below. In a preferred embodiment the interview step 400 comprises an on-line series of data input screens and data processing functions. As illustrated schematically, in FIG. 1 this interactive data processing step is carried out until completion and generates data sufficient to create a legal document. These data (“document contents”) are transferred from the interactive portion of the program or website to a facility 500 that converts them into a document, e.g., a word processing program or document image program such as Adobe®.

Thus, in accordance with the present invention, an end-user of the software initializes the software in a manner known and conventional in the art, either by executing the program locally or by activating a hypertext link to an appropriate network page using a conventional browser program. In a preferred embodiment, the user is first presented with several choices as to the complexity of the document desired. In a preferred embodiment of the present invention, the end user is first presented with three choices. However, as opposed to the choices found in prior art systems, the preferred embodiment of the present invention permits the user to select between three levels of complexity based upon both subjective and objective criteria, rather than based solely upon a few objective criteria such as statutory limits or number of persons in a family. Thus, in accordance with a preferred embodiment of the present invention, a first level of complexity can be chosen, and as described in detail below, a software program made in accordance with the present invention will elicit complex financial and personal data and will ask the end user to make numerous sophisticated and detailed choices within the criteria provided by those data. A second level of complexity will require significant data entry, but less data than the most complex level. The data are processed from a more limited number of options that are made available, with more assumptions made on what a typical user would select if faced with every option; however, the end user will still address all major and some minor issues. The third level, the most simple, requires limited data input and makes a large number of assumptions, thereby requiring the end user to make minimum choices. This third level of complexity resembles the prior art software described above where a user chooses between a few basic will formats, based largely on statutory criteria.

Upon selection as between several levels of complexity, the user proceeds to operate the software program. Described below are the features and sets of data inputs associated with preferred embodiments of the present invention. Using all of them represents the first, most complex level of operation referred to above, although additional features may be added beyond those described herein. Additionally, it should be understood that in certain situations, the second level of complexity described herein may use most, if not all of, the features described below when the first, more complex level includes additional financial and estate calculations driven by statutes, regulations and practice. In this regard, it would be understood that a practitioner using the software described herein directed to a market of highly affluent individuals with large estates might have a “middle” level of complexity that is as complex or even more complex that another practitioner that wishes to encompass a broader market and chooses a middle level for less sophisticated individuals with relatively smaller estates. The most simple, least complex level will always be a relatively limited “fill in the blanks” set of forms.

In a preferred embodiment of the present invention, the user is first asked to enter basic personal and family data, e.g., name(s), spouse names, children's names, parents, etc. In a preferred embodiment, a dialog box is filled in and a button is clicked to advance the program. Upon entry of an answer to each question, the screen is refreshed and a new question and information will appear. In accordance with the present invention and as explained below, none of the inquiries that elicit these data require the user to make a choice or have foreknowledge of the legal or financial implications of the data. The next section of the program collects financial information, and as the financial information is collected, the program categorizes, collects and processes the data to determine a financial worth based upon the data entered. In one of the preferred embodiments, the present invention is implemented via an interactive website and the query and text box are arrayed on a web page that includes commentary and information to help the end user assess the correct answer. Additionally, in such embodiments, it will be further preferred to provide hypertext links to other web pages that are useful while the user is attempting to answer the query, e.g., a link to a financial terms glossary or to financial calculators.

After the user has entered financial data, calculations are performed and a financial summary is provided, as well as an assessment of the potential tax saving strategies that can be employed. The user is then asked if they wish certain scenarios to apply to their estate, by checking off one of several statements as being true. In other words, rather than asking the user to self-select a trust or other instrument, the user instead responds to questions regarding the user's personal, family, and financial situation, as well as factors determined by the state law of the user's domicile, and the processes of the software determine the document that is appropriate based on the user responses. If a trust is appropriate, the software next asks questions seeking the names of trustees and the desires of the grantor of the trust in terms of distributions and the manner in which the trust is administered. In certain embodiments of the present invention, an additional feature will be that certain of the data entry screens will have no default value and not accept a null value; a dialog box requiring entry of data will appear if the user does not enter an appropriate response. In most instances, this system can be used to provide guidance and helpful reminders to the person using the software to ensure that all the entries are accurate and all contingencies have been considered.

After the user has finished inputs of all the data required, a will and/or other document is generated. In a preferred embodiment, the document is selectively downloaded to the user, and may either be printed using the browser printing function or may be printed from a word processing program.

Although certain embodiments of the present invention have been described in detail herein, those of skill in the art will apprehend that numerous modifications, extensions, and adaptations of the inventions described herein will immediately present themselves and will not depart from the spirit of the present invention. Thus, in order to ascertain the full scope of the present invention, reference should be made to the appended claims.

What is claimed is:

1. A method of automatically generating a will or trust document, comprising the steps of:
providing a user with a plurality of input screens, arranged in a sequential and logical order, wherein said screens include one or more screens requiring: personal and family information, financial information, asset information, estate distribution selections, trust parameter selection, and guardian and trustee selections; and processing data input by an end-user to automatically create a will or trust document

2. The method of claim 1, further comprising the step of selectively precluding a user from viewing a second screen subsequent a first screen until data is entered into said first screen.

3. The method of claim 1, further comprising the prefatory step of selecting between a plurality of levels of complexity, wherein each level of complexity requires less input data from said input screens.

4. The method of claim 3, wherein there are three levels of complexity.

5. A software program for effecting a method of effecting an interactive process, wherein there are at least three levels of interaction, one of which is selected by an end user, wherein said three levels comprise:
a first level wherein a user inputs a first data set to a plurality of data input sections, and a null entry is not permitted;
a second level of less complexity that said first level wherein said software program makes assumptions based on limited data input by an end user, wherein said limited data is less data than said first data set; and
a third level of less complexity than said second level wherein said software program selects between several pre-determined outputs based upon basic data input by an end user, wherein said basic data is less data than said limited data set.

6. The software program of claim 6 wherein the interactive process is the process of generating a will or trust.

7 A method of generating a will or trust document using a computing device comprising the steps of:
providing a plurality of data entry questions to collect personal and financial data;
processing said data to calculate net worth and other parameters relevant to a will or trust;
processing said data to create a printable document, that includes both data entered directly by and end user and data derived from data entered by an end user.

8. The method of claim 7, comprising the prefatory step of selecting between one more levels of complexity for the document.

9. The method of claim 7, wherein there are three levels of complexity.

10. The method of claim 7, further comprising the step of precluding processing said data to create a printed document in a null value is entered for one or more of said data entry questions.
